(19) United States
(12) Patent Application Publication
(10) Pub. No.: US 2010/0147071 A1
(43) Pub. Date: Jun. 17, 2010

(54) Matter-Wave Gravimeter Incorporated into an Atom Chip

(75) Inventors: Sylvain Schwartz, Saint-Remy Les Chevreuse (FR); Jean-Paul Pocholle, La Norville (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/360,800

(22) Filed: Jan. 27, 2009

(30) Foreign Application Priority Data
Dec. 16, 2008 (FR) 08 07072

(51) Int. Cl. G01V 7/00

(52) U.S. Cl. 73/382 R

(57) ABSTRACT

The general field of the invention is that of gravimeters, of the matter-wave type, allowing the measurement of the gravitational field or of an acceleration in a given direction of measurement. This type of gravimeter uses ultracold atoms to take the measurement. It necessarily comprises an atom trap (5) making it possible to immobilize an ultracold atom cloud (10) in a determined configuration and means (7) for splitting-recombining the cloud into two atom packets placed at different heights so as to create a phase shift due to gravity. The device according to the invention combines both these functions on an atom chip (3) mainly comprising means for generating a local magnetic field minimum around a first conductor wire (30), a second conductor wire (31) and a third conductor wire (32) that are substantially parallel in the zone of the trap to the first conductor wire and are placed symmetrically on either side of this first wire, the second wire being traversed by a first alternating current, the third wire being traversed by a second alternating current of the same amplitude and of the same frequency as the first alternating current and in the opposite direction, the amplitudes of the first and of the second currents being able to vary simultaneously, the maximum amplitude and the frequency of said currents being sufficient to create at the atom cloud a magnetic field with an intensity greater than the magnetic intensity necessary to split the atom cloud into two atom packets.

### PRIORITY CLAIM

This application claims priority to French Patent Application Number 08 07072, entitled Matter-Wave Gravimeter Incorporated into an Atom Chip, filed on Dec. 16, 2008.

### BACKGROUND OF THE INVENTION

1. Field of the Invention

The field of the invention is that of gravimetry, that is to say the measurement of the local gravity field and/or of its gradient, and more particularly of high-precision gravimetry. The field of application of high-precision gravimeters is extremely wide. In a nonlimiting manner, it is possible to cite the search for anomalies in the gravitational field for the detection of hidden objects such as cavities or tunnels, space applications, inertial navigation or geophysical applications such as oil prospecting. It is naturally possible to use this type of device as an accelerometer.

2. Description of the Prior Art

The high-precision gravimeters that currently exist may be divided into two categories. The first is based on effects of conventional mechanics. Thanks to the study of macroscopic mass objects, which may be, for example, free-fall cube-corner mirrors associated with an optical detection, local gravity is determined. However, the complexity, the fragility, the volume and the cost of such objects limit their practical use.

The second category of high-performance gravimeters is based on the use of matter-waves. The latter, which are associated with any mass particle according to the laws of quantum mechanics, are specifically sensitive to the local gravitational field, which induces a phase shift that can be measured by atomic interferometry. It can be demonstrated that, for the effects of the matter-waves to be practically observable, it is necessary to use atoms cooled to temperatures situated at a few billionths of degrees above absolute zero. In the rest of the text, these atoms will be called cold or ultracold atoms.

The principle of this type of sensor has already been demonstrated successfully in several laboratories. Reference should be made, for example, to the publication of M. Snadden, J. McGuirk, P. Bouyer, K. Haritos and M. Kasevich, Measurement of the Earth's Gravity Gradient with an Atom Interferometer-Based Gravity Gradiometer, Physical Review Letters 81, pages 971-974 (1998). In this example, the measurement principle is based on the use of pulse transfers between cold atoms and laser beams by Raman transition. Also cited is the publication of M. Kasevich and S. Chu, Atomic interferometry using stimulated Raman transitions, Physical Review Letters 67, pages 181-184 (1991) on this subject. The performances obtained with this type of device are comparable, and even superior to the gravimeters based on the previously cited conventional mechanics. Size however remains a considerable limitation for this type of device for practical uses, even though recent efforts have made it possible to use an atomic gravimeter loaded onto a truck, as part of the “PINS” project at Stanford University.

In parallel, considerable efforts have been deployed in recent years to integrate a portion of the functions for trapping, cooling and manipulating cold atoms on devices of the “chip” type, the latter having the advantage of compactness but also of better control of the magnetic fields necessary and of reduced electricity consumption. In addition, the value of using and integrating radiofrequency fields for the coherent manipulation of atoms, emphasized since 2000 in an article by O. Zobay and B. Garraway, Two-Dimensional Atom Trapping in Field-Induced Adiabatic Potentials, Physical Review Letters 86, pages 1195-1198 (2001), has recently been demonstrated experimentally by the coherent separation into two equal portions of a Bose-Einstein condensate in 2006, which constitutes the atomic equivalent of a separating blade for a laser, a key component for producing atom interferometers. For further information, reference should be made to the publication of T. Schumm et al., Matter-wave interferometry in a double well on an atom chip, Nature Physics 1, pages 57-62 (2005).

### SUMMARY OF THE INVENTION

The gravimeter according to the invention proposes, based on the existing technologies in atom gravimetry and coherent manipulation of matter waves on atomic chips, an innovative architecture of a sensor, for measuring the local gravitational field, its gradient or the accelerations to which the device is subjected.

More precisely, the subject of the invention is a gravimeter of the matter-wave type, allowing the measurement of the gravitational field or of an acceleration in a given direction of measurement, said gravimeter comprising at least:
an electronic chip comprising a measuring plane;
means for generating, capturing and cooling an ultracold atom cloud and an atom trap making it possible to immobilize the ultracold atom cloud at a predetermined distance from said measuring plane;
the magnetic trap comprising an assembly of conductor wires integrated into said chip and external coils allowing the production of a local magnetic field minimum in the vicinity of the chip; such a trap may, for example, consist, on the one hand, of a first conductor wire incorporated into said chip traversed by a substantially constant current I_{DC} and, on the other hand, of means for generating a uniform magnetic field the field lines of which are, in the zone of the trap, parallel to the measuring plane and perpendicular to the direction of the first conductor wire;
means for splitting the atom cloud into two packets of atoms for a determined period at a determined distance in a direction parallel to the direction of measurement, said means also making possible the recombination of the two packets into a single atom cloud;
optical means for measuring the phase shift introduced onto the atom cloud after recombination;
electronic means for controlling, commanding and slaving of the various means of the gravimeter;
   characterized in that the separation means essentially comprise a second conductor wire and a third conductor wire that are substantially parallel in the zone of the trap to a first main conductor wire and are placed symmetrically on either side of this first wire, the second wire being traversed by a first alternating current, the third wire being traversed by a second alternating current of the same amplitude and of the same frequency as the first alternating current and in the opposite direction, the amplitudes of the first and of the second current being able to vary simultaneously, the maximum amplitude and the frequency of said currents being sufficient to create at the atom cloud an alternative magnetic splitting field with an intensity greater than the magnetic intensity necessary to split the atom cloud into two atom packets in the direction of polarization of said magnetic field.

Advantageously, the means for cooling the ultracold atom cloud and the atom trap are arranged so that the atom cloud is a Bose-Einstein condensate.

In addition, the gravimeter may comprise at least a second atom trap identical to the first atom trap, placed in the vicinity of a second zone of the measuring plane of the electronic chip, the first, the second and the third conductor wire being common to the two traps, the electronic means comprising functions making it possible to make comparisons or to perform mathematical functions between the measurements obtained by the first trap and the measurements obtained by the second trap.

The invention also relates to a method of measuring the gravitational field or an acceleration in a given direction of measurement by means of a gravimeter, of the matter-wave type, said gravimeter comprising at least:
an electronic chip comprising a measuring plane;
means for generating, capturing and cooling an ultracold atom cloud and an atom trap making it possible to immobilize the ultracold atom cloud;
the trap comprising on the one hand a first main conductor wire and conductor wires incorporated into said chip and, on the other hand, external means for generating a magnetic field resulting in a local magnetic field minimum in the vicinity of the chip;
means for splitting the atom cloud into two packets of atoms, said splitting means essentially comprising a second conductor wire and a third conductor wire substantially parallel in the zone of the trap to the first conductor wire and placed symmetrically on either side of this first wire, the second wire being traversed by a first alternating current, the third wire being traversed by a second alternating current of the same amplitude, of the same frequency as the first alternating current and in the opposite direction, the amplitudes of the first and of the second current being able to vary simultaneously,
optical means for measuring the phase shift introduced on the atom cloud after recombination;
electronic means for controlling, commanding and slaving of the various means of the gravimeter;
characterized in that the taking of a measurement comprises the following phases:
Phase 1, called the generation phase: Generation, cooling and trapping of an ultracold atom cloud at a predetermined distance from said measuring plane;
Phase 2, called the splitting phase: Progressive and simultaneous increasing of the first and second alternating currents until the amplitude and the frequency of said currents are sufficient to create at the atom cloud a magnetic field with an intensity greater than the magnetic intensity necessary to split the atom cloud into two atom packets, the two packets being separated by a determined distance in a direction parallel to the direction of measurement;
Phase 3, called the interrogation phase: Maintenance of the amplitudes of the alternating currents so as to preserve the split for a predetermined period of time;
Phase 4, called the recombination phase: Reduction of the amplitudes of the alternating currents so as to recombine the two atom packets into a single phase-shifted atom cloud;
Phase 5, called the measurement phase: Measurement of the phase shift by the optical measuring means.

### BRIEF DESCRIPTION OF THE DRAWINGS

The invention will be better understood and other advantages will appear on reading the following description given in a nonlimiting manner and thanks to the appended figures amongst which:

FIG. 1 represents the general technical principle of a matter-wave gravimeter;

FIGS. 2a and 2b represent a possible principle for generating a local magnetic field minimum on the surface of a chip;

FIG. 3 represents a top view of the measuring plane of a first electronic chip of the gravimeter according to the invention comprising a single atom trap;

FIGS. 4a and 4b represent two important steps in the gravimetric measuring method according to the invention;

FIG. 5 represents a top view of the measuring plane of a second electronic chip of the gravimeter according to the invention comprising a plurality of atom traps.

### MORE DETAILED DESCRIPTION

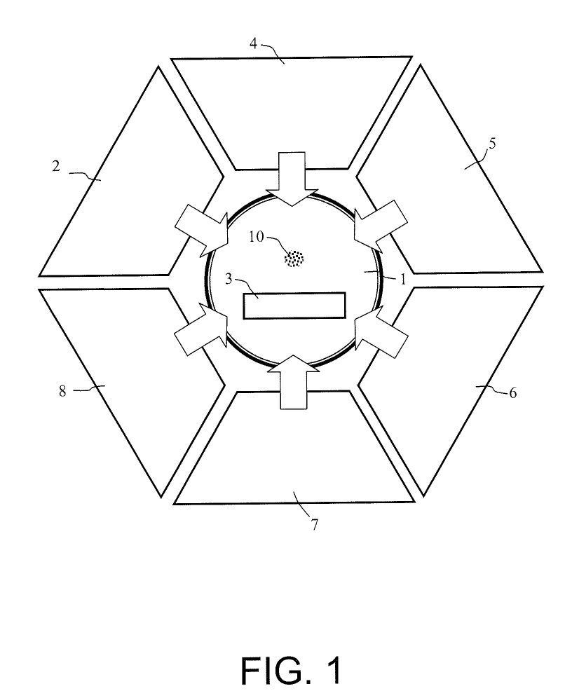

FIG. 1 represents the general block diagram of the main technical components of a matter-wave gravimeter according to the invention. The device comprises a vacuum enclosure 1 maintained for example with the aid of an ion pump and comprising a magnetic shield, an atom generator 2, better known as an atom “dispenser”. This dispenser is, for example, a heating filament delivering a rubidium vapor. The device also comprises an atom chip 3 and optionally external sources of magnetic field, a first optical assembly 4 allowing the capture and pre-cooling of the atoms 10 before they enter the magnetic trap 5, and a second detection optical assembly 6 at the end of the sequence which may be provided, for example, by a camera of the CCD type. The device also comprises means 7 for splitting the atom cloud. An electronic device 8 is also necessary for controlling the various elements and for the temporal synchronization of the various steps of the measurement from the capture to the detection of the atoms. The publication of S. Du et al., Atom-chip Bose-Einstein condensation in a portable vacuum cell, Physical Review A 70, 053606 (2004) is a good example of integration of this type of device in a compact volume.

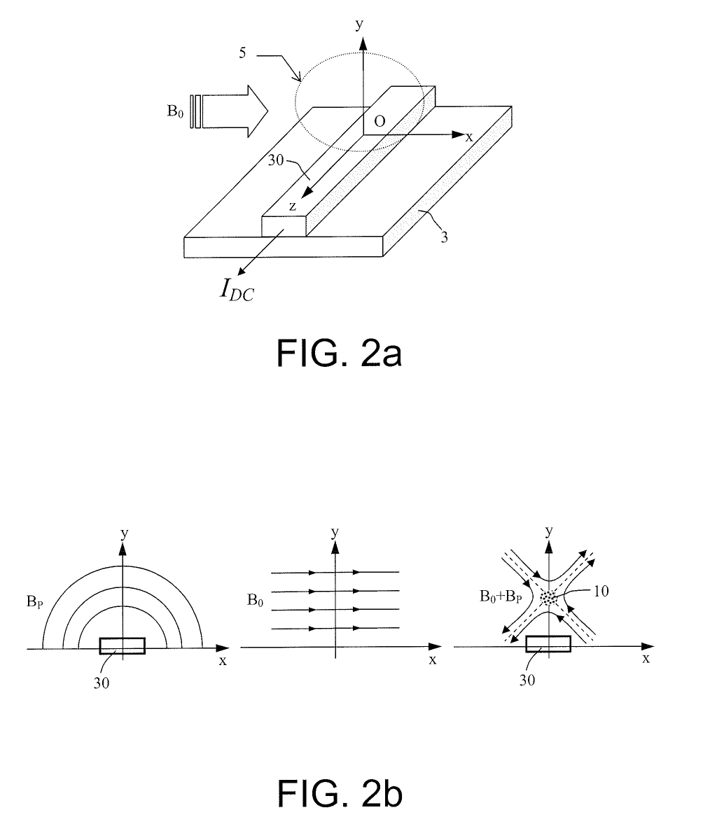

In the device according to the invention, the atoms are trapped by a magnetic trap 5 the principle of which, known to those skilled in the art, is schematically represented in FIGS. 2a and 2b. The cloud of cold atoms is trapped by a minimum magnetic field created in the vicinity of a chip 3 by an assembly of printed wires 30 on the latter, optionally combined with external sources of magnetic field. The trapping of the atoms 10 relies on the interaction between the magnetic field and the total magnetic dipole of the atoms, which are attracted or repulsed, depending on their internal condition, by the field extrema. In the example of FIG. 2, the field minimum is created by the combination of the magnetic fields B_{P} generated by the conductor wires 30 of the chip 5 and of a constant or bias magnetic field B₀ generated by external coils not represented in FIG. 2. FIG. 2a represents a view in perspective of a portion of the chip 3 and of the conductor wire 30 and the Cartesian coordinate system (0, x, y, z) which is used for the subsequent figures. The direction of measurement is parallel to the axis Oy. FIG. 2b shows, in a plane (O, x, y), to the left of the semicircular magnetic field lines created by a conductor wire 30 traversed by a current I_{DC}, in the center the rectilinear field lines due to the “magnetic bias” and on the right the superposition of the magnetic fields which creates the magnetic trap above the conductor wire 30. The field lines then have in a plane (0, x, y) as a first approximation a shape like a capital X as indicated in FIG. 2b, the atoms being trapped in the center of the X. Such a trap may possibly be anisotropic, for example strongly confining in two directions of the space and more weakly confining in the third. The detailed description of all of the elements making it possible to obtain such a source of cold atoms on the surface of a chip is given in the literature. It is possible, for example, to refer to the publication of R. Folman et al., Microscopic atom optics: from wires to an atom chip, Advances in Atomic, Molecular, and Optical Physics 48, pages 263-356 (2002).

It is known, according to the aforementioned references, that it is possible, with the aid of such a configuration, to obtain an assembly of cold atoms in a magnetic trap at a distance h₀ from the chip given approximately by:

$${h}_{0} \approx \frac{{μ}_{0} {I}_{DC}}{2 π {B}_{0}} , \qquad ( A )$$

where μ₀ is the magnetic permeability of the vacuum. The typical order of magnitude for the distance h₀ is a hundredth of a micrometer. The latter and therefore the atoms transported along the axis y may be modified by varying the parameters I_{DC} or B₀.

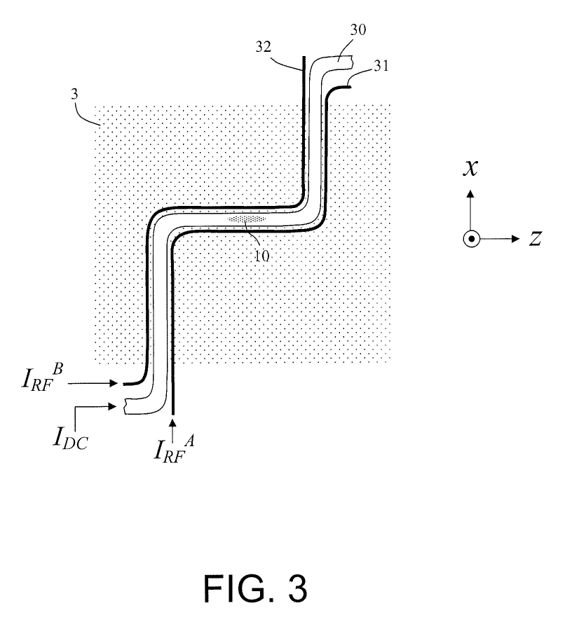

The device must also comprise means for splitting the atom cloud. Therefore, in the device according to the invention, on either side of the main wire 30, two other wires 31 and 32 are placed traversed by alternating currents I_{RF}^{A} and I_{RF}^{B}, designed to generate a radio frequency field for the coherent separation of the atoms. FIG. 3 represents a top view of this arrangement in which the central wire traversed by a constant current is represented in white and the lateral wires, placed symmetrically relative to the central wire and traversed by alternating currents are represented in black lines. It is known also that the application of a radiofrequency field makes it possible to modify the potential seen by the atoms, by inducing a coupling between magnetic sublevels. Refer to the publication of Lesanovsky et al., Adiabatic radio-frequency potentials for the coherent manipulation of matter waves, Physical Review A 73, 033619 (2006) on this subject.

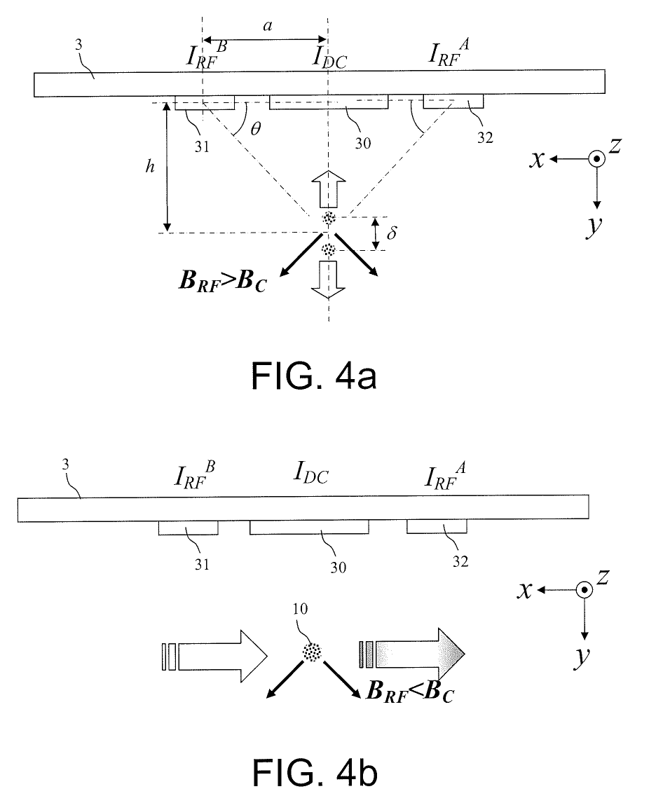

More precisely, FIG. 4a represents the application of a radiofrequency field B_{RF} polarized along the axis y and generated at the center of the atom trap, by applying for example in the radiofrequency wires 31 and 32 the following intensities:

I_{RF}^{A}=I₀ cos(ω_{RF}t) and I_{RF}^{B}=−I₀ cos(ω_{RF}t). (B)

Letting a be the distance separating a peripheral wire 31 or 32 from the central wire 30 and letting θ be the angle such that

$$tg ( θ ) = \frac{{h}_{0}}{a} ,$$

the radiofrequency magnetic field seen by the atoms may then be expressed as a function of the geometric parameters θ and a as follows:

$${B}_{RF} = {B}_{RF}^{0} cos ( {ω}_{RF} t ) sin θ {e}_{y}$$

$$where$$

$${B}_{RF}^{0} = \frac{{μ}_{0} {I}_{0} cos θ}{2 π a} .$$

In the publication of Lesanovsky already cited, it is demonstrated that, when the value of B_{RF}⁰ sin θ is greater than a certain critical value B_{C}, this field induces a vertical separation of the atom cloud into two portions that are distant by the following value δ:

$$δ = \frac{\sqrt{2}}{G} \sqrt{{( {B}_{RF}^{0} sin θ )}^{2} - {B}_{C}^{2}} \\ where \\ G \approx \frac{{B}_{0}}{{h}_{0}} . \qquad ( C )$$

The parameter G is the gradient of the quadripolar field of the loffe trap. Still according to the same reference, the critical radiofrequency field leading to the separation of the atom cloud into two portions is given by:

$${B}_{C} = 2 \sqrt{{B}_{0 z} \frac{κ {B}_{0 z} - ℏ {ω}_{RF}}{\vert κ \vert}} ,$$

where B₀ₓ is the component of the constant magnetic field that it is necessary to apply along the axis z in order to obtain a confining trap in the three dimensions and where the factor k is given by the expression k=g_{F}μ_{B}, where μ_{B} is the Bohr magneton and g_{F} is the gyromagnetic factor marked g-factor of the level in question. Naturally, to obtain effectively a separation of the packet of atoms into two packets, the depth of the potential well along the axis y must be greater than the potential energy difference induced by gravity.

These two tools being introduced, magnetic trapping of the atoms and radiofrequency separation, the steps of the method according to the invention that leads to the measurement of gravity along the axis y are:
1) capture and cooling of the atoms according to the conventional methods described in the literature, resulting in obtaining a cloud of cold atoms, advantageously a Bose-Einstein condensate in the center of the magnetic trap, situated at a distance h, given by the equation (A), above the atom chip;
2) progressive application in the conductor wires 31 and 32 of a radiofrequency field according to the equation (B), which leads to the adiabatic vertical separation of the atom cloud by a distance δ, given by the equation (C) as shown in FIG. 4a which represents a view in section in the plane (O, x, y) of the atom chip at the atomic trap;
3) interrogation phase of a duration T, during which the fields may be kept constant or be modified for the purpose of increasing sensitivity;
4) recombination phase, during which the radiofrequency field is progressively brought below the critical value of separation;
5) detection phase that can take place in situ or advantageously after a flight time phase. The payload signal is constituted by the phase of the atom density network formed on the gaseous cloud, and may be obtained by absorption imaging. This phase is illustrated in FIG. 4b where the optical detection is symbolized by two straight horizontal arrows.

It is demonstrated that (on this subject refer to C. Cohen-Tannoudji, Propagation d'une particule dans un champ de pesanteur (Propagation of a particle in a gravity field), Cours du Collège de France, dated Dec. 15, 1992:
the phase shift F sustained by an atom of mass M along a trajectory y(t) in a gravity field g, assumed to be aligned along the axis y, is given by the following expression:

$$Φ = \frac{Mg}{ℏ} \int y ( t ) d t .$$

In the simplest version of the invention, the two packets of atoms are at altitudes y=h±δ/2 during the interrogation period T, hence the following phase shift ΔΦ between the two packets of atoms after recombination:

$$ΔΦ = \frac{Mg}{ℏ} δ T . \qquad ( D )$$

Measuring ΔΦ makes it possible to return to that of the gravity g provided that the values δ and T are sufficiently accurately known, which does not present particular difficulties.

It should be noted that, when the device described above is subjected to an acceleration, the latter is added to the gravity field in the expression of the total phase shift. This shows that the device according to the invention may be used as an accelerometer if it is assumed that the gravity field is known, or if the axis of measurement is oriented perpendicularly to the gravity field.

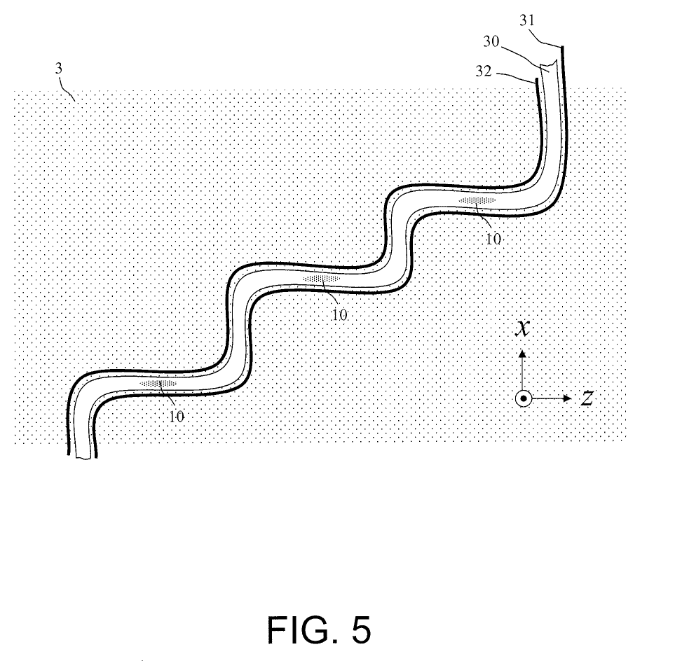

When precise gravity field measurements have to be taken, it is appropriate to dispense with the effects other than gravity that can introduce a phase shift between the two wave packets. These effects are for example the mechanical vibrations, or the inhomogeneities of the trapping potentials. The measuring device according to the invention may comprise several of the sensors described above on the same chip as indicated in FIG. 5 in order to obtain a set of phase measurements that are sensitive to the same parasitical effects as the mechanical vibrations or inhomogeneities of the trapping potentials. The measured magnitude is then no longer the absolute gravity field, but rather the variation of the gravity field from one sensor to the other. The sharpness of the detection obtained then increases with the number of sensors. Effects associated with the anisotropy of the detected objects may also be observed. Advantageously, a maximum of means such as the magnetic fields and the electric currents which are associated with them are placed in common or reproduced identically from one sensor to the other in order to optimize the rejection effect sought.

It emerges from the equation (D) that the sensitivity of an atomic gravimeter is determined by the parameter δT, that is to say the product of the spatial separation and of the interaction time. If we take as a reference the atomic gravimeter produced at the SYRTE (SYstème de Référence Temps-Espace (time-space reference system)) of the Paris Observatory, it emerges from the thesis of D. Holleville, Conception et réalisation d'un gyromètre à atomes froids fondé sur l'effet Sagnac pour les ondes de matières (Design and production of a cold atom gyrometer based on the Sagnac effect for matter-waves), the doctorate thesis for the University of Paris XI (2001), that a micro-acceleration of 2 10⁻⁴ m/s² produces a phase shift of 2π with cesium atoms and a δT of approximately 1.5 10⁻² m.s. With the device according to the invention it is possible to achieve typical values of the order of δ≈100 μm and T=1 s, hence δT≈10⁻⁴ m.s. This loss of sensitivity relative to the SYRTE device may be compensated for on the one hand by an improvement in the signal-to-noise ratio by using an atom laser instead of the thermal clouds used in the atomic gravimeter produced at the SYRTE, and on the other hand by placing several sensors in series on the same chip, which allows the common effects to be rejected. The integration on the chip also provides a very significant improvement in the integration and the final volume of the gravimeter.

In summary, the main advantages of the device according to the invention are:
Integration on a single chip of one or more matter-wave gravimeters in order to reject the common parasitical effects and allowing differential measurement;
Possible use of coherent atomic sources called Bose-Einstein condensates thanks to the use of radiofrequency separators instead of Raman beams. This improves the signal-to-noise ratio and reduces the optical power required;
Gain in compactness, in integration and in electrical consumption thanks to the integration on an atomic chip;
Signal-to-noise ratio much better than the conventional atomic sources thanks to the coherent atomic sources, hence possible performances equivalent to the best current atomic gravimeters and in any case much better than conventional gravimeters;
   Placing in series of several sensors which makes it possible, on the one hand, to considerably improve the stability of the bias on this device and, on the other hand, to produce new methods of detecting gravitational field anomalies, no longer based on the gradient but on a combination of a large number (more than 3) of different measurement points.

What is claimed is:

1. A gravimeter, of the matter-wave type, allowing the measurement of the gravitational field or of an acceleration in a given direction of measurement, said gravimeter comprising at least:
an electronic chip comprising a measuring plane;
means for generating, capturing and cooling an ultracold atom cloud and an atom trap making it possible to immobilize the ultracold atom cloud at a predetermined distance from said measuring plane;
the trap comprising on the one hand at least a first main conductor wire incorporated into said chip and, on the other hand, means for generating an external magnetic field resulting in a local magnetic field minimum in the vicinity of the chip;
means for splitting the atom cloud into two packets of atoms for a determined period at a determined distance in a direction parallel to the direction of measurement, said means also making possible the recombination of the two packets into a single atom cloud;
optical means for measuring the phase shift introduced onto the atom cloud after recombination;
electronic means for controlling, commanding and slaving of the various means of the gravimeter;
wherein the separation means essentially comprise a second conductor wire and a third conductor wire that are substantially parallel in the zone of the trap to the first conductor wire and are placed symmetrically on either side of this first wire, the second wire being traversed by a first alternating current, the third wire being traversed by a second alternating current of the same amplitude and of the same frequency as the first alternating current and in the opposite direction, the amplitudes of the first and of the second current being able to vary simultaneously, the maximum amplitude and the frequency of said currents being sufficient to create at the atom cloud a magnetic splitting field with an intensity greater than the magnetic intensity necessary to split the atom cloud into two atom packets in the direction of polarization of said magnetic field.

2. The gravimeter as claimed in claim 1, wherein the means for cooling the ultracold atom cloud and the atom trap are arranged so that the atom cloud is a Bose-Einstein condensate.

3. The gravimeter as claimed in claim 1, wherein the gravimeter comprises at least a second atom trap identical to the first atom trap, placed in the vicinity of a second zone of the measuring plane of the electronic chip, the first, the second and the third conductor wire being common to the two traps, the electronic means comprising functions making it possible to make comparisons or to perform mathematical functions between the measurements obtained by the first trap and the measurements obtained by the second trap.

4. A method of measuring the gravitational field or an acceleration in a given direction of measurement by means of a gravimeter, of the matter-wave type, said gravimeter comprising at least:
an electronic chip comprising a measuring plane;
means for generating, capturing and cooling an ultracold atom cloud and an atom trap making it possible to immobilize the ultracold atom cloud;
the trap comprising on the one hand a first main conductor wire incorporated into said chip and, on the other hand, external means for generating a magnetic field resulting in a local magnetic field minimum in the vicinity of the chip;
means for splitting the atom cloud into two packets of atoms, said splitting means essentially comprising a second conductor wire and a third conductor wire substantially parallel in the zone of the trap to the main conductor wire and placed symmetrically on either side of this first wire, the second wire being traversed by a first alternating current, the third wire being traversed by a second alternating current of the same amplitude, of the same frequency as the first alternating current and in the opposite direction, the amplitudes of the first and of the second current being able to vary simultaneously,
optical means for measuring the phase shift introduced on the atom cloud after recombination;
electronic means for controlling, commanding and slaving of the various means of the gravimeter;
wherein the taking of a measurement comprises the following phases:
Phase 1, called the generation phase: Generation, cooling and trapping of an ultracold atom cloud at a predetermined height in the vicinity of said measuring plane;
Phase 2, called the splitting phase: Progressive and simultaneous increasing of the first and second alternating currents until the amplitude and the frequency of said currents are sufficient to create at the atom cloud a magnetic splitting field with an intensity greater than the magnetic intensity necessary to split the atom cloud into two atom packets, the two packets being separated by a determined distance in a direction parallel to the direction of measurement;
Phase 3, called the interrogation phase: Maintenance of the amplitudes of the alternating currents so as to preserve the split for a predetermined period of time;
Phase 4, called the recombination phase: Reduction of the amplitudes of the alternating currents so as to recombine the two atom packets into a single phase-shifted atom cloud;
Phase 5, called the measurement phase: Measurement of the phase shift by the optical measuring means.

5. The gravimeter as claimed in claim 2, wherein the gravimeter comprises at least a second atom trap identical to the first atom trap, placed in the vicinity of a second zone of the measuring plane of the electronic chip, the first, the second and the third conductor wire being common to the two traps, the electronic means comprising functions making it possible to make comparisons or to perform mathematical functions between the measurements obtained by the first trap and the measurements obtained by the second trap.
